(19) United States
(12) Patent Application Publication
(10) Pub. No.: US 2003/0165249 A1
(43) Pub. Date: Sep. 4, 2003

(54) Acoustic apparatus for preventing howling

(75) Inventor: Shinichi Higuchi, Fukushima-ken (JP)

Correspondence Address: BRINKS HOFER GILSON & LIONE, P.O. BOX 10395, CHICAGO, IL, 60611, US

(73) Assignee: Alps Electric Co., Ltd.

(21) Appl. No.: 10/376,867

(22) Filed: Feb. 27, 2003

(30) Foreign Application Priority Data
Mar. 1, 2002 (JP) 2002-055326
Mar. 1, 2002 (JP) 2002-055327

(51) Int. Cl. H04R 1/02; H04R 1/20

(52) U.S. Cl. 381/318; 381/353; 381/345

(57) ABSTRACT

When a sound signal is received, a sound wave generated on an upper surface of a vibration plate is transmitted to a sound collection portion through a first air passage, and a sound wave generated on a lower surface of the vibration plate is transmitted to the sound collection portion through a second air passage. The sound waves generated above and below the upper and lower surfaces of the vibration plate are about 180 degrees out of phase from each other and substantially cancel each other which minimize or prevent howling.

### BACKGROUND OF THE INVENTION

1. Field of the Invention

This invention relates to an acoustic apparatus having an integrated microphone and a speaker. More particularly, the invention relates to an apparatus that improves speaker and/or microphone sensitivity.

2. Description of the Related Art

When a microphone and a speaker are positioned close to each other within a case, often the microphone detects the sound (vibration) generated by the speaker and converts that sound into an electric signal. That electrical signal is then converted again to a sound by a speaker. A “howling” or oscillation state develops through this feedback between the microphone and the speaker.

In some communication devices, such as cellular telephones, the microphone and the speaker are spaced far apart to avoid howling. However, when the microphone and the speaker are spaced far apart, communication equipment, including cellular devices cannot always be miniaturized.

Alternatively, dedicated electronic circuits and software have been used in communication equipment to avoid howling. When dedicated electronic circuits are used, circuit assembly can be complicated and the cost of production can increase.

### SUMMARY OF AN EMBODIMENT OF THE INVENTION

An acoustic embodiment includes a support, a sound generation portion having a vibration plate, and a vibration generation portion for driving the vibration plate. The acoustic apparatus embodiment includes a sound collection portion responsive to an external sound, a first sound pressure transmission portion that transmits a sound pressure produced by a first side of the vibration plate, a sound collection portion that receives the vibration generated by the vibration plate, and a second sound pressure transmission portion that transmits a sound pressure generated on a second side of the vibration plate.

In the acoustic embodiment, the sound pressure generated by the first side of the vibration plate is substantially out of phase with the sound generated by the second side of the vibration plate, when the sound generation portion generates sound. Therefore, when a sound generation portion and a sound collection portion are in close proximity to each other or are integrated together, feedback and howling can be suppressed or minimized.

The first sound pressure transmission portion can be comprised of an air passage that communicates with an external space near the vibration plate within the sound collection portion. The second sound pressure transmission portion can comprise an air passage that communicates with an internal space positioned between the inside of the vibration plate and a support coupled to the sound collection portion.

Preferably, at least one of the first and second sound pressure transmission portions comprise a diaphragm. The diaphragm can be made of many materials including a metal foil or an extensible resin material. Preferably, the diaphragm vibrates in response to the sound pressure of the vibration plate which applies a sound pressure to the sound collection portion.

In one embodiment, the acoustic apparatus may include a microphone case that supports an inner edge of a portion of the vibration plate. Preferably, the sound collection portion is disposed within the microphone case. An integral speaker and a microphone having a first and second sound pressure transmission portions can also be positioned within the microphone case.

The acoustic apparatus embodiment may further include a support coupled to an outer periphery of the vibration plate, a microphone case disposed outside the outer periphery of the vibration plate, a sound collection portion disposed within the microphone case, and a speaker and a microphone. Preferably, the speaker and microphone comprises first and second sound pressure transmission portions positioned near each other within the microphone case.

According to another aspect, an acoustic embodiment includes a sound generation portion that generates sound and a sound collection portion responsive to an external sound pressure. Preferably, the sound generation portion includes a first vibration plate that generates sound, a driving coil that vibrates the first vibration plate, and a magnetic circuit that generates a magnetic field that crosses the driving coil. Preferably, the sound collection portion includes a second vibration plate for collecting sound, a detection coil that is responsive to the second vibration plate, and a magnetic circuit that generates a magnetic field crossing the detection coil. Preferably, the acoustic apparatus further comprises an auxiliary coil that vibrates with the first vibration plate during a sound generation mode caused by a vibration of the first vibration plate, and a current circuit having a detection coil and an auxiliary coil. Preferably, current is induced in the auxiliary coil of the current circuit when the first vibration plate vibrates the second vibration plate, which substantially cancels the induced current generated in the detection coil.

In this embodiment, a current is induced in the auxiliary coil when the first vibration plate generates sound. When the first vibration plate is driven, the second vibration plate of the sound collection portion vibrates. A current flowing through the auxiliary coil in the current circuit substantially cancels the induced current flowing in the detection coil, thereby suppressing the reflected or sound energy (e.g., howling). Preferably, the driving coil and the auxiliary coil are coupled to a same side of the first vibration plate.

When the embodiment is used as a microphone, the second vibration plate will vibrate in response to an external sound. Preferably, the first vibration plate also vibrates in a common or same direction. Preferably, the current induced in the auxiliary coil adds to the current induced in the detection coil, which increases the sensitivity of the microphone. When the driving coil and the auxiliary coil are positioned within a common magnetic circuit, the magnetic circuit can be easily produced.

Preferably, the driving coil, the detection coil, and the auxiliary coil are wound in a same direction, and the direction of the magnetic fields crossing the driving coil, the detection coil, and the auxiliary coil are flow in a same direction.

The driving coil and the auxiliary coil can be connected either in series or in parallel. It is also possible to use other electronic components such as switches and linear circuits (e.g., transistors and resistors) to assemble the current circuit.

### BRIEF DESCRIPTION OF THE DRAWINGS

FIG. 1 is a sectional view showing an acoustic embodiment;

FIG. 2 is an enlarged sectional view of a sound collection portion as a main portion of FIG. 1;

FIG. 3 is a sectional view of an alternative sound collection portion;

FIG. 4 is a sectional view of an acoustic apparatus according to a second embodiment;

FIG. 5 is a sectional view of an acoustic apparatus according to a third embodiment;

FIG. 6A shows a detection coil and an auxiliary coil, operating as a speaker;

FIG. 6B shows the detection coil and the auxiliary coil, operating as a microphone;

FIG. 7A shows the detection coil and the auxiliary coil operating as a speaker; and

FIG. 7B shows the detection coil and the auxiliary coil operating as a microphone.

### DESCRIPTION OF THE PREFERRED EMBODIMENTS

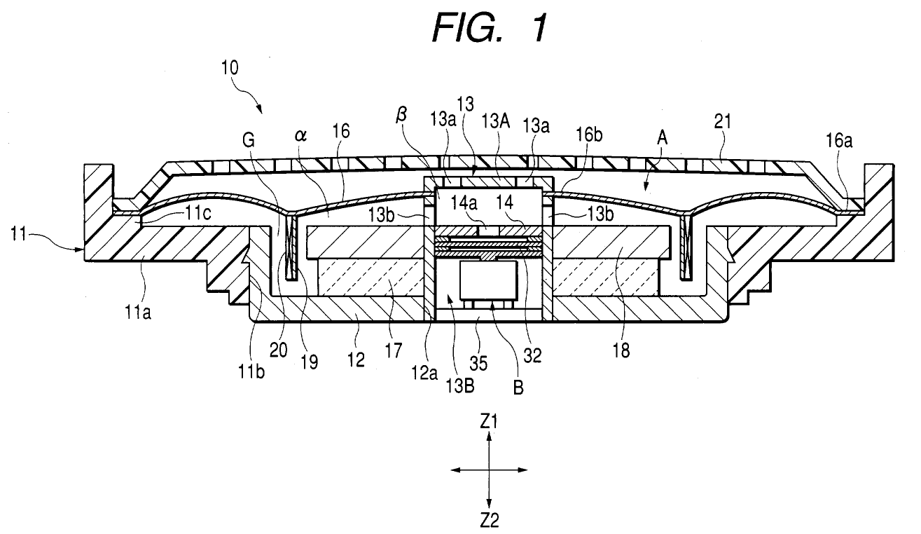

An acoustic apparatus 10 shown in FIG. 1 includes a frame 11. Preferably, the frame 11 is made through an injection process using a synthetic resin material or die cast molding process using an aluminum alloy or a zinc alloy.

In the illustrated embodiment, the frame 11 is molded from a synthetic resin into a dish-like shape that has an annular outer periphery support portion 11a. An opening 11b having a large inner diameter passes through a center portion of the frame 11. Preferably, a lower yoke 12 made of a magnetic material and having a recessed shape is fitted to the opening 11b. In this embodiment, the frame 11 and the lower yoke 12 comprise a support. A sound generation portion A is positioned above and a sound collection portion (microphone) B positioned adjacent to the support.

An opening 12a having a smaller diameter than opening 11b is formed near the center of the lower yoke 12. Preferably, a microphone case 13 is fitted through the opening 12a. Preferably, the microphone case 13 has a substantially cylindrical shape that can be formed of a synthetic resin or a non-magnetic metal, for example. Preferably, a closing end portion 13A closes one end of the microphone case 13. The closing end portion 13A can be integrally formed with the microphone case 13 in front (on a Z1 side) of a sound generation side. An opening end portion 13B that opens into the microphone case 13 is formed at the back (on a Z2 side) of the microphone case 13.

Preferably, a vibration plate 16 is positioned above the support 11 and the lower yoke 12. The vibration plate 16 can be formed of a paper material, a laminate body of paper, a resin film, a paper material impregnated with a resin, or many other materials. A peripheral portion 16a near the outer periphery of the vibration plate 16 is fixed to an upper surface of a step portion 11c formed on the outer periphery support portion 11a of the frame 11. Preferably, a hole passes through a center of the vibration plate 16. Preferably, an edge portion 16b near an inner peripheral side of the hole is fixed to an outer peripheral surface of the microphone case 13 on the front side (on the Z1 side). Preferably, the vibration plate 16 is capable of vibrating. A sealed internal space α is bounded by the support 11, lower yoke 12 and the vibration plate 16.

A cylindrical bobbin 19 extending in a Z2 direction in FIG. 1 preferably is fixed to the lower surface of the vibration plate 16. Preferably, a voice coil 20 is wound around an outer peripheral surface of the bobbin 19.

An upper yoke 18 comprising a ring-like permanent magnet and a magnetic material is fitted to the outer peripheral side surface of the microphone case 13 above the lower yoke 12. Upper and lower surfaces of a permanent magnet 17 are magnetized to opposite polarities. For example, the Z1 side shown in the drawings is magnetized to a north seeking magnetic pole and the Z2 side is magnetized to a south seeking magnetic pole. Preferably, a gap “G” is formed between the edge portion of the upper yoke 18 and the inner wall of the lower yoke 12. Preferably, the bobbin 19 and the voice coil 20 are positioned within the gap “G”.

In this embodiment, the permanent magnet 17, the upper yoke 18, the gap “G”, the voice coil 20, and the lower yoke 12 comprise a magnetic driving portion of a vibration generation portion. When sound is received by the voice coil 20 of the magnetic driving portion, an electromagnetic force and a magnetic field passing through the gap “G” vibrate the bobbin 19 in the Z direction and the vibration plate 16 generates sound corresponding to the received sound signal. Preferably, the magnetic driving portion and the vibration portion 16 comprise the sound generation portion A.

Preferably, a partition member 14 partitions the closing end-portion 13A and the open end portion 13B. As shown, the partition member 14 is disposed within the microphone case 13 at a position that is farther away from the open end portion 13B (on the Z2 side in the drawing) than the fixing position of the vibration plate 16. Preferably, a pressure-sensitive space β is formed between the closing end portion 13A and the partition member 14 within the microphone case 13.

A first air passage 13a that functions as a first sound pressure transmission portion passes through the closing end portion 13A of the microphone case 13. A second air passage 13b that functions as a second sound pressure transmission portion passes through the side surfaces of the microphone case 13 between the closing end portion 13A and the partition member 14. Preferably, the second air passages 13b are positioned below the fixing position of the vibration plate 16. Preferably, the first air passage 13a connects the front side space (on the Z1 side) of the vibration plate 16 with the pressure-sensitive space β. Preferably, the second air passage 13b connects the internal space α with the pressure-sensitive space β.

Preferably, a sound collection portion B that functions as a microphone or a device that converts sound waives into analog and/or digital data is disposed within the microphone case 13. The sound collection portion B is interposed between the partition member 14 and a lower cover 35. Preferably, a through-hole 14a passes through the partition member 14 to link the pressure-sensitive space β to the sound collection portion B.

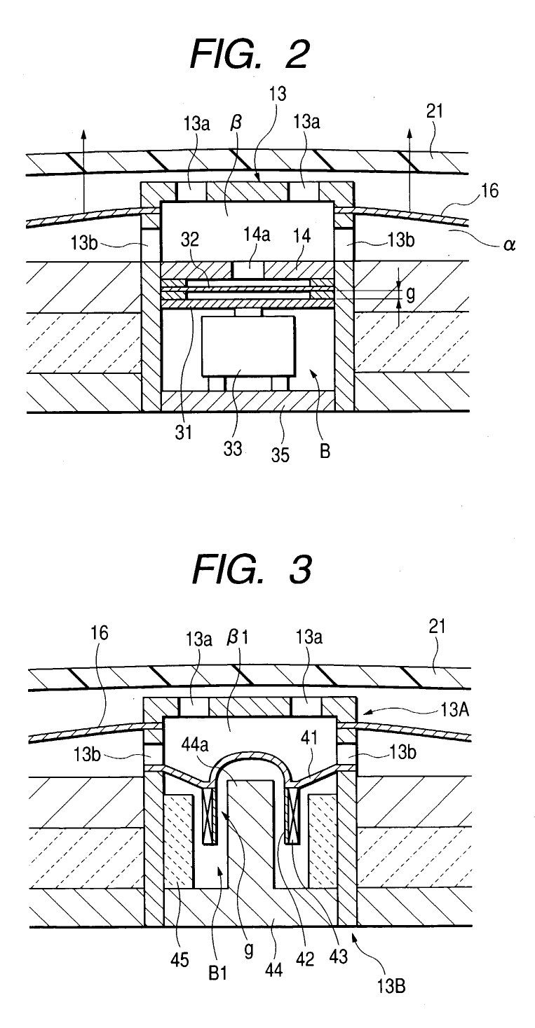

Preferably, the sound collection portion B includes a fixed electrode 31 and a vibration film 32. Preferably, the vibration film is interposed between the fixed electrode 31 and the partition member 14 as shown in FIG. 2. The vibration film 32 can comprise an electric film that is formed by a polarization treatment, for example. A peripheral portion of the vibration film 32 is held within the microphone case 13 and a gap “g” is formed between the vibration film 32 and the fixed electrode 31.

Pickup means 33 is electrically connected to the fixed electrode 31. The pickup means 33 can include an impedance conversion circuit. In the illustrated embodiment, the impedance conversion circuit comprises a FET disposed on a substrate. Preferably, the substrate is supported by a lower cover 35 fixed to the open end portion 13B of the microphone case 13.

In one embodiment, the pickup means 33 accumulates electrical charge between the fixed electrode 31 and the vibration film 32. In some embodiments, the pickup means comprises a fixed or variable capacitor. When a sound pressure within the pressure-sensitive space β vibrates the vibration film 32, the shape and volume enclosed by the opposing gap “g” changes, and the electrostatic potential between the fixed electrode 31 and the vibration film 32 changes. The pickup means 33 detects this change in electrostatic potential and acquires an electric signal corresponding to the sound pressure of the pressure-sensitive space β.

Preferably, a resonance plate 21 covering the open portion 11b of the frame 11 is fitted to the step portion 11c of the frame 11. The vibration plate 16 is held between the edge portion of the resonance plate 21 and the step portion 11c. Preferably many openings, perforations, or slits pass through or are so formed in the resonance plate 21. In FIG. 1, the openings are aligned in a Z direction.

When a sound signal is received by the voice coil 20 of the magnetic driving portion, the electromagnetic force generated by the current flowing through the voice coil 20 and the magnetic field inside the gap “G” vibrates the bobbin 19, which vibrates the voice coil 20 and the vibration plate 16. Vibration of the vibration plate 16 generates a sound pressure in the front space and a sound that travels in a forward direction.

The intensity of the sound pressure generated in the forward direction by the vibration plate 16 (e.g., in the Z1 direction), can depend on the density of air in the front space. Preferably, the forward moving sound pressure is transmitted into the pressure-sensitive space β of the microphone case 13 through the first air passage 13a by a reflection. As the forward sound pressure travels into the pressure-sensitive space β, the sound pressure generated in the internal space α near the back of the vibration plate 16 is transmitted to the pressure-sensitive space β within the microphone case 13 through the second air passage 13b.

In this instance, the sound pressure in front of the vibration plate 16 and the sound pressure inside the internal space α have almost mutually opposite densities and have about a 180° phase difference. Therefore, the sound pressures that are nearly 180° out of phase with each other are offset or substantially cancelled within the pressure-sensitive space β of the microphone case 13. Preferably, the summations of these sound pressures substantially cancel and do not cause or cause a limited vibration of the vibration film 32. When the vibration plate 16 of the sound generation portion A vibrates and emits a forward sound in this acoustic embodiment, the sound generation preferably does not or almost does not vibrate the vibration film 32. By eliminating or minimizing the vibration of the vibration film 32 the reflected sound, energy, or howling occurrence can be suppressed or minimized.

In this embodiment, the sealed internal space α is bounded by the back surface of the vibration plate 16. Therefore, the sound pressure originating from the back surface of the vibration plate 16 can be easily transmitted to the pressure-sensitive space β through the second air passage 13b. Since the pressure sensitive-space β is positioned above the sound collection portion B and the sound pressures having mutually opposite phases are summed in the pressure-sensitive space β, the sound pressure applied to the vibration film 32 opposing this pressure-sensitive space β can be easily offset or minimized.

In alternative embodiments, a communication passage is formed that communicates with the internal space α outside of the support portion 11a and can adjust the magnitude of the sound pressure generated within the internal space α.

Preferably, when sound is received in the space bounded by the front side (on the Z1 side) of the resonance plate 21, the sound wave travels through the holes of the resonance plate 21, the first air passage 13a, and the through-hole 14a. Preferably, the sound vibrates the vibration film 32 of the sound collection portion B within the microphone case 13.

Preferably, a side of the vibration plate 16 near the sound generation portion A also simultaneously vibrates. At that instant, preferably, the sound pressure applied to the internal space α is transmitted to the pressure-sensitive space β through the second air passage 13b. Preferably, the sound pressure from the first air passage 13a and the sound pressure from the second air passage 13b are transmitted substantially in phase to the pressure-sensitive space β. Since both sound pressures have the same or about the same phase, the sound pressure that vibrates the vibration film 32 on the sound collection portion side B is amplified, and the sound collection sensitivity of the sound collection portion B is preferably improved.

As explained, this embodiment can provide an acoustic apparatus that can prevent reflections or howling when the acoustic embodiment operates as a speaker. When the acoustic embodiment operates as a microphone, preferably, the embodiment has an improved sensitivity.

FIG. 3 is a sectional view of an alternative sound collection portion. In this acoustic apparatus embodiment, an electro-magnetic conversion type sound collection portion B1 is formed within a microphone case 13. A vibration film 41 within the sound collection portion B1 is suspended from the microphone case 13. Preferably, the vibration film slopes downward from an inner wall of the microphone case 13 to a convex portion. Preferably, a bobbin 42 having a voice coil 43 wound thereon is positioned at or near an end of the linear and convex portions of the vibration film 41.

Preferably, a first air passage 13a passes through a closing end portion 13A of the microphone case 13 and a second air passage 13b passes through a side surface of the microphone case 13 between the closing end portion 13A and the vibration film 41. The first air passage 13a and the second air passage 13b preferably communicate with a pressure-sensitive space β1 partially bounded by a front surface of the vibration film 41.

A yoke member 44 having a substantially T-shaped cross-section is preferably coupled to the microphone case 13. Preferably, a concave portion bounded by a permanent magnet 45 and the yoke member 44 is configured to receive the bobbin 42. Preferably, the permanent magnet 45 has a ring-like shape enclosed within the microphone case 13. An inner surface of the permanent magnet 45 and a convex portion 44a of the yoke member 44 bounds a gap “g” that receives the bobbin 42 and the voice coil 43.

Preferably, the magnetic flux radiating from the permanent magnet 45 passes through the gap “g,” the voice coil 43, and enters the convex portion 44a, and then returns to the permanent magnet 45 through the inner portion of the yoke member 44. Preferably, this path forms a magnetic circuit.

In an acoustic apparatus embodiment having a sound collection portion B1 as described-above, the sound pressures generated above and below the vibration plate 16 are about 180 degrees out of phase from each other as they are received by the pressure-sensitive space β1. Preferably, the phase difference prevents the vibration film 41 of the sound collection portion B1 from vibrating and effectively suppresses or minimizes a howling effect.

When the acoustic apparatus embodiment operates as a microphone, preferably the sound pressure applied by the front side of the vibration plate 16 on the side near the sound generation portion A and the sound pressure generated near the back of the vibration plate 16 are received in the pressure-sensitive space β1 through the first air passage 13a and the second air passage 13b, respectively, substantially in phase. Preferably these sound pressures sum, resulting in an amplified sound pressure transmitted to the vibration film 41.

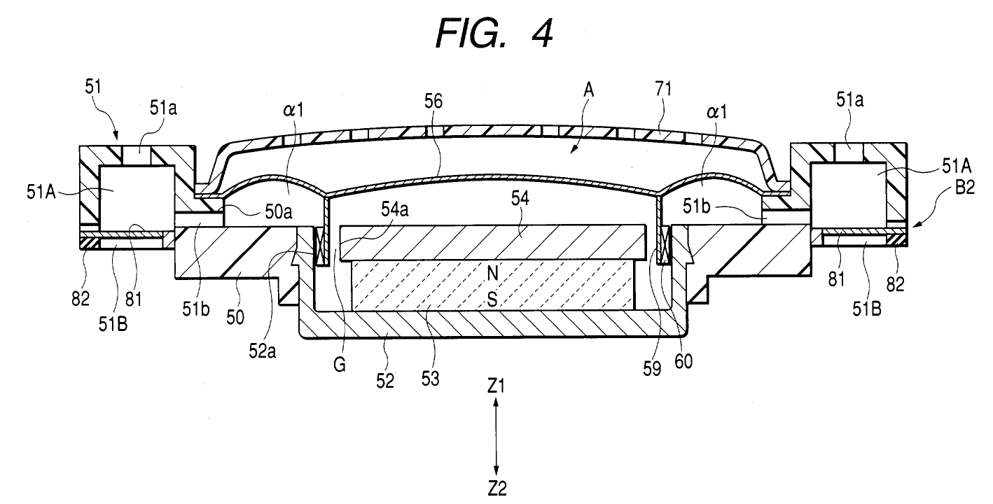

FIG. 4 is a sectional view of an acoustic apparatus embodiment. In the acoustic apparatus embodiment shown in FIG. 4, a lower yoke 52 formed of a magnetic material and having a rectangular shape is positioned near the center of a frame 50. Preferably, a permanent magnet 53 is fixed near the center of the lower yoke 52. The permanent magnet 53 is magnetized to the N pole on the Z1 side in the drawing and to the S pole on the Z2 side.

Preferably, an upper yoke 54 formed of a magnetic material is fixed to the upper end face of the permanent magnet 53, and its end face 54a in an outer peripheral direction is positioned across from an inner wall 52a of the lower yoke 52. Preferably, a predetermined gap “G” is disposed between them.

Preferably, a step portion 50a is formed around an outer peripheral side of the frame 50. Preferably, an edge of a vibration plate 56 is fixed to the step portion 50a. Preferably, a resonance plate 71 that covers the vibration plate 56 is fitted to the step portion 50a. Preferably, a plurality of holes passes through the resonance plate 71.

A bobbin 59, preferably made of a paper material, is fixed to a lower portion of the vibration plate 56. Preferably, a linear portion of the vibration plate 56 is positioned adjacent to a voice coil 60. Preferably, the voice coil is wound on the outer peripheral surface of the bobbin 59. Preferably, the bobbin 59 and voice coil 60 are positioned within the gap “G.”

In this embodiment, the lower yoke 52, the permanent magnet 53, the upper yoke 54, the gap “G”, and the voice coil 60 comprise a magnetic driving portion of a vibration generation portion. Preferably, a magnetic circuit (or magnetic path) is formed by a path linking the N pole of the permanent magnet 53 to the outer edge portion of the upper yoke 54, to the gap “G,” to the voice coil 60, to the inner wall of the lower yoke 52, to the S pole of the permanent magnet 53.

Preferably, a plurality of microphone cases 51 are integrally formed with the frame 50. The microphone cases 51 are shown adjacent to an outer peripheral side outside of a step portion 50a of the frame 50. Preferably, the microphone cases 51 are disposed at a plurality of positions around the outer peripheral portion of the frame 50.

Preferably, a pressure-sensitive space 51A is formed within each of the microphone cases 51. An open portion 51B formed or cut out in a horizontal direction is positioned near the bottom surface of each microphone case 51. A vibration plate 81 is disposed above this open portion 51B. Pickup means 82 is disposed at the edge of the vibration plate 81. The pickup means 82 can comprise, for example, an energy conversion type strain sensor that converts the vibration or motion of the vibration plate 81 into an electric signal.

In one embodiment the pickup means 82 senses changes in resistance. In other embodiments, the pickup means senses the potential differences created by differences in physical pressure, like a piezoelectric device or a carbon microphone. Preferably, a sound collection portion B2 is formed on the outer peripheral side of the frame 50 in this embodiment.

Preferably, a first air passage 51a comprises a first sound pressure transmission portion that communicates with a space positioned in front of the vibration plate 56 and with the inner pressure-sensitive space 51A formed in the microphone case 51. A second air passage 51b comprising a second sound pressure transmission portion communicates with an internal space α1 bounded by the microphone case 51 and the frame 50 near the back of the vibration plate 56 and further communicates with the pressure-sensitive space 51A formed within the microphone case 51.

When the vibration plate 56 on the sound generation side A vibrates, preferably the sound pressure applied to the front of the vibration plate 56 and the sound pressure applied to the back of the vibration plate 56 are offset or substantially out of phase within the pressure-sensitive space 51A, which minimizes or suppresses the howling effect of this embodiment.

When functioning as a microphone, preferably, sound is applied to the sound collection portion B2. That sound pressure is then transmitted to the pressure-sensitive space 51A through the first air passage 51a, while the sound pressure occurring at the back of the vibrating vibration plate 56 is transmitted to the pressure-sensitive space 51A through the second air passage 51b at the same time. Consequently, these multiple sound pressures transmitted into the pressure-sensitive space 51A are added amplifying the original signal. Preferably, as the amplitude of the vibration transmitted to the vibration plate 81 becomes greater, the sensitivity of the sound collection portion B2 improves.

Preferably, this embodiment prevents howling when the sound collection portion is disposed either within or outside of the sound generation portion. Preferably, the structure of the sound collection portion is not limited to a capacitor type or an electromagnetic conversion type, but can also be used with many other structures. For example, a piezoelectric type portion comprising a piezoelectric material and an energy conversion type such as a carbon microphone can also be used.

In one embodiment, a microphone and any one of a electromagnetic conversion type, capacitor type, piezoelectric type and/or the energy conversion type of sound collection portion can be used. In the present embodiments, the support that supports the vibration plate and the sound collection portion may be a unitary structure, or can be separate structures.

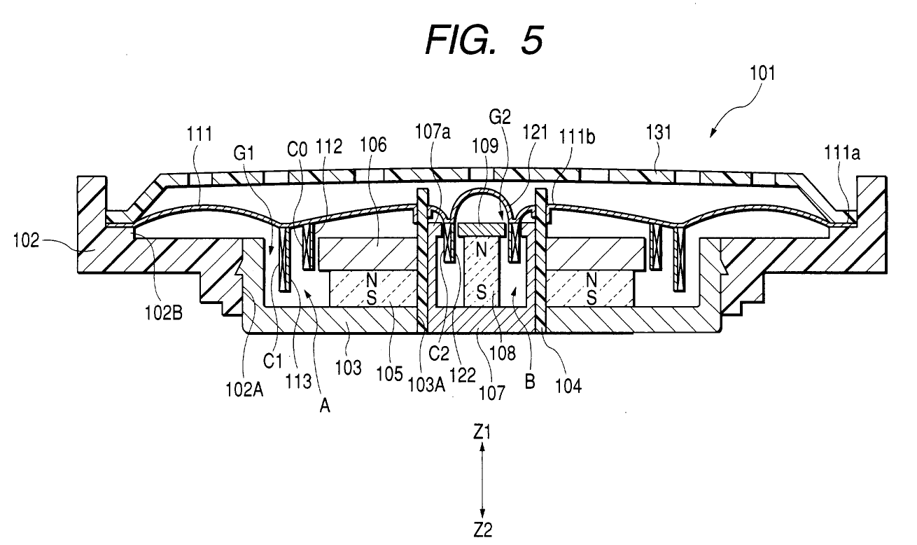

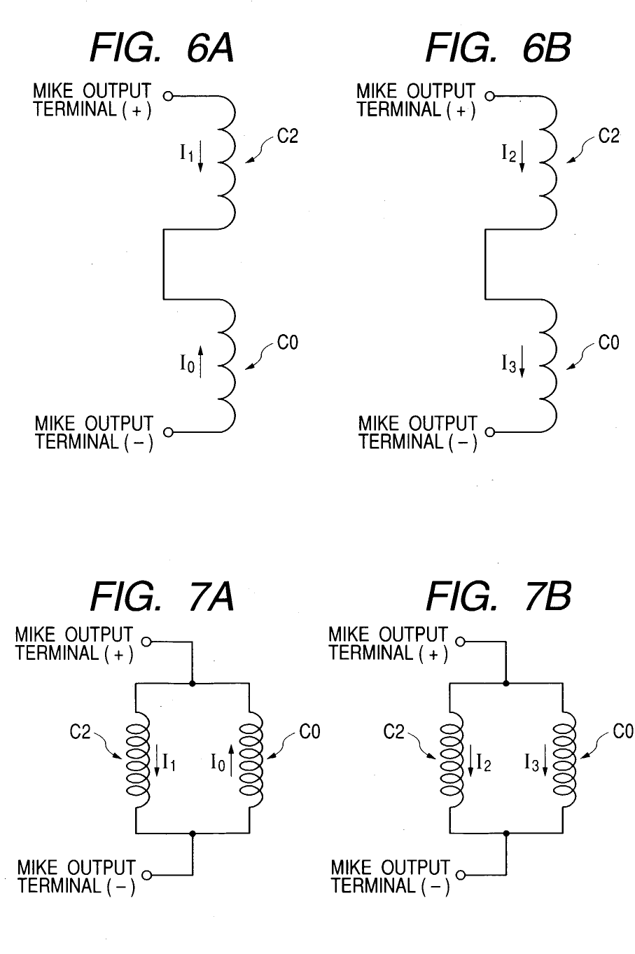

FIG. 5 illustrates a sectional view of an acoustic apparatus according to a third embodiment. FIGS. 6 and 7 show examples of current circuits that include a detection coil and an auxiliary coil. In these drawings, the symbol A indicates that the acoustic apparatus is operating as a speaker and the symbol B represents the case where the acoustic apparatus operates as a microphone.

An acoustic apparatus 101 shown in FIG. 5 includes a frame 102. Preferably, the frame 102 is shaped by an injection molding process using a synthetic resin material or a die cast molding process using an aluminum alloy or a zinc alloy. In one embodiment, a frame 102 is molded into a dish-like shape using a synthetic resin material. Preferably, an open portion 102A having a large inner diameter passes through a portion of the acoustic apparatus. Preferably, a center lower yoke 103 formed of a magnetic material and having a recessed shape is fitted through this open portion 102A. In this embodiment, the frame 102 and the lower yoke 103 together comprise a support. Sound generation portion A and sound collection portion (microphone) B are preferably positioned on the support.

An open portion 103A having a small diameter is formed near the center of the lower yoke 103. A microphone case (center pole) 104 is fitted to the open portion 103A. Preferably, the microphone case 104 is molded into a cylindrical shape. In one embodiment, the microphone case can be molded from a synthetic resin material or a non-magnetic metal material.

Preferably, a first vibration plate 111 supports the sound generation portion. The vibration plate 111 can be formed of a paper material, a laminate material, a paper material with a resin film, or a paper material impregnated with a resin, for example. An edge portion 111a positioned near the outer peripheral side of the vibration plate 111 is fixed to an upper surface of a step portion 102B formed near an outer peripheral portion of the frame 102. A hole is opened near the center of the vibration plate 111. An edge portion 111b positioned near the inner peripheral side of the periphery of this hole is preferably fixed to the outer peripheral surface of the microphone case 104 on its front side. Preferably, the vibration plate 111 is supported so that it is capable of vibration.

Preferably, a cylindrical bobbin 113 extending in a Z2 direction in FIG. 5 is fixed to a lower surface of the vibration plate 111. Preferably, a driving coil C1 is wound on the outer peripheral surface of the bobbin 113. A cylindrical bobbin 112 concentric with the bobbin 113 is fixed to the inner peripheral side of the bobbin 113. Preferably, an auxiliary coil C0 is wound on this bobbin 112.

Preferably, an upper yoke 106 comprised of a magnetic material is positioned adjacent to the outer periphery of the microphone case 104 over the ring-like permanent magnet 105 and an upper yoke 106. Upper and lower side surfaces of the permanent magnet 105 are preferably magnetized to opposite polarities. For example, the Z1 side shown in FIG. 5 is magnetized to an N pole and the Z2 side is preferably magnetized to the S pole. Preferably, a gap “G1” for driving is formed between the outer peripheral surface of the upper yoke 106 and the inner surface of the outer peripheral portion of the lower yoke 103. Preferably the first bobbin 113 and the driving coil C1, and the second bobbin 112 and the auxiliary coil CO, are positioned within the driving gap “G1”.

Preferably, the magnetic field generated by the permanent magnet 105 comprises a magnetic circuit having an electrical path extending from the upper yoke 106 to the inner surface of the outer peripheral portion of the lower yoke 103 within the gap “G1,” through the driving coil C1 and the auxiliary coil C0. Preferably, the driving coil C1 is wound in the same direction as the winding of the auxiliary coil C0.

In this embodiment, the permanent magnet 105, the upper yoke 106, the gap “G1,” the driving coil C1 and the lower yoke 103 comprise a magnetic driving portion of a vibration generation portion. The magnetic driving portion and the vibration plate 111 comprise a sound generation portion A. The permanent magnet 105, the upper yoke 106, the gap “G1”, the auxiliary coil C0 and the lower yoke 103 comprise an auxiliary magnetic driving portion that preferably prevent howling.

Preferably, a sound collection portion B functioning as part of a microphone is arranged within the microphone case 104. A cup-like internal yoke 107 is fixed within the sound collection portion B. A lower surface of a cylindrical permanent magnet 108 preferably is positioned near the center of the bottom surface of the internal yoke 107. Preferably, a disc-like opposing yoke 109 is fixed to an upper surface of the permanent magnet 108. In this embodiment, both the internal yoke 107 and opposing yoke 109 are made of a magnetic material. Preferably, a protrusion portion 107a that protrudes in a center direction and is positioned close to the opposing yoke 109 is formed on an inner peripheral surface of an upper end of the internal yoke 107. A gap “G2” for detection is formed between the protrusion portion 107a and a side surface of the opposing yoke 109. Preferably, the internal yoke 107, the permanent magnet 108, and the opposing yoke 109 comprise a magnetic circuit for detection.

A second vibration plate 121 having a W-like shape cross-section is disposed within the microphone case 104. An outer edge portion of the second vibration plate 121 is peripherally fixed to an inner wall of the microphone case 104. Preferably, cylindrical bobbin 122 is coupled to a portion of the second vibration plate 121 and a detection coil C2 is wound on an outer peripheral surface of the bobbin 122. Preferably, the second bobbin 122 is directly adjacent to the detection coil C2 both of which are positioned within the gap “G2.”

In this embodiment, the permanent magnet 108, the opposing yoke 109, the gap “G2,” the detection coil C2, and the internal yoke 107 comprise a magnetic detection portion. The magnetic detection portion and the second vibration plate 121 comprise the sound collection portion B. Preferably, the driving gap “G1” can convey the magnetic field in the same direction as that of the detection gap “G2,” and preferably, the driving coil C2 is wound in the same direction as the detection coil C2, the driving coil C1, and the auxiliary coil C0.

Preferably, detection coil C2 and the auxiliary coil C0 are part of a same current circuit. The coils C2 and C0 shown in FIGS. 6A and 6B, for example, are connected in series. Alternatively, coils C2 and C0 in FIGS. 7A and 7B are connected in parallel.

A resonance plate 131 that covers the first and second vibration plates 111 and 121 is coupled to the step portion 102B of the frame 102. Preferably, a plurality of holes are formed in the resonance plate 131.

Preferably, when a sound signal is received by the driving coil C1 of the sound generation portion A, the electromagnetic force generated by the magnetic flux crossing the driving coil C1 and the current flowing through the driving coil C1 vibrate the driving coil C1 that drives the first vibration plate 111 in the Z direction. As this occurs, sound corresponding to the sound signal is transmitted forward (in the Z1 direction) from the first vibration plate 111.

The sound pressure transmitted forward from the first vibration plate 111, that is, the vibration due to the density of air in the forward space, is transferred to the second vibration plate 121, which vibrates the second vibration plate 121. Preferably, a current I1 is induced in the detection coil C2 that vibrates with the second vibration plate 121. FIGS. 6A and 7A illustrate the direction of this current I1 at a certain point in time.

When the first vibration plate 111 is vibrating, a current I0 flows through the auxiliary coil C0 that vibrates with the first vibration plate 111. Preferably, the direction of the vibration of the first vibration plate 111 is opposite to that of the second vibration plate 121, and their phases differ by about 180 degrees. Therefore, in FIG. 6A or 7A, the current I0 generated in the auxiliary coil C0 has a direction that is opposite to the current I1 induced in the detection coil C2. As a result, even when the first vibration plate 111 is driven to generate sound and its sound pressure drives the second vibration plates 121, current does not substantially flow from the detection coil C2. As a result, howling can be prevented or minimized.

A structure that substantially cancels the currents by adding I0 and I1 can be formed by adjusting the ratio of the number of turns of the detection coil C2 to the number of turns of the auxiliary coil C0. Preferably, the ratio can be adjusted in accordance with the difference of intensity of a magnetic field between the permanent magnet 105 and the permanent magnet 108 and with the difference between the driving gap “G1” and the detection gap “G2”.

When sound is generated in the space in front of (on the Z1 side) of the resonance plate 131, the sound wave is transmitted within the acoustic apparatus embodiment through the holes passing through the resonance plate 131. When sound passes through these holes the second vibration plate 121 of the sound collection portion B within the microphone case 104 vibrates. In this mode, the acoustic apparatus operates as a microphone.

When operating as a microphone, the vibration of the second vibration plate 121 of the sound collection portion B induces a detection current I2 within the detection coil C2. Arrows shown in FIGS. 6B and 7B represents the direction of this current I2 at a certain point in time. When the external sound pressure vibrates the second vibration plate 121, this sound pressure also vibrates the first vibration plate 111. The phase of vibration of the first vibration plate 111 is preferably about the same as the phase of vibration of the second vibration plate 121. Therefore, as shown in FIGS. 6B and 7B, the I3 current direction induced in the auxiliary coil C0 flows in the same direction as that of the current I2 induced in the detection coil C2. Therefore, when operating as a microphone, the detection sensitivity of the sound collection portion B is amplified; this improves sensitivity.

In one embodiment, the driving coil C1 and the auxiliary coil C0 are wound on the different bobbins 112 and 113, but the invention is not limited to these structures. In an alternative embodiment, the driving coil C1 and the auxiliary coil C0 are wound on one bobbin.

As described, the acoustic embodiment can cancel sound generated by the sound generation portion before the sound collection portion picks up the sound. Therefore, the embodiment can prevent or minimize howling.

When the acoustic apparatus embodiment operates as a microphone, the sound wave transmitted from the sound source to the sound collection portion and the sound wave transmitted through the vibration plate of the sound generation portion can be transmitted to the sound collection portion in phase with each other. Therefore, the addition of these sounds can improve the sound collection sensitivity of the sound collection portion.

When the acoustic apparatus operates as a speaker, the current induced in the auxiliary coil of the sound generation portion substantially cancels the current induced in the detection coil of the sound collection portion. Preferably some of the vibrations of the vibration plate of the sound collection portion are suppressed.

When the acoustic embodiment operates as a microphone, the current induced in the auxiliary coil of the sound generation portion and the current induced in the detection coil of the sound collection portion can be amplified. Moreover, the detection sensitivity of the overall acoustic embodiment increases, which increases sensitivity of the acoustic embodiment.

While some embodiments of the invention have been described, it should be apparent that many more embodiments and implementations are possible and are within the scope of this invention. It is intended that the foregoing detailed description be regarded as illustrative rather than limiting, and that it be understood that it is the following claims, including all equivalents, that are intended to define the spirit and scope of this invention.

What is claimed is:

1. An acoustic apparatus comprising a sound generation portion comprising a vibration plate and a vibration generation portion that drives said vibration plate, and a sound collection portion responsive to an external sound pressure, comprising:
a first sound pressure transmission portion that transmits a sound pressure generated from a first side of said vibration plate to said sound collection portion when said vibration plate generates sound; and
a second sound pressure transmission portion that transmits a sound pressure generated from a second side of said vibration plate to said sound collection portion when said vibration plate generates sound.

2. An acoustic apparatus according to claim 1, wherein said first sound pressure transmission portion comprises an air passage that communicates with an external space of said vibration plate and with said sound collection portion, and said second sound pressure transmission portion comprises an air passage that communicates with an internal space disposed between an inner side of said vibration plate and a support of said sound collection portion.

3. An acoustic apparatus according to claim 1, which further comprises a microphone case that supports an inner edge of a center portion of said vibration plate, and wherein said sound collection portion is disposed within said microphone case, and said first and second sound pressure transmission portions are coupled to said microphone case.

4. An acoustic apparatus according to claim 1, wherein a support supports an outer periphery of said vibration plate, a microphone case is disposed outside of an outer periphery of said vibration plate, said sound collection portion being disposed in said microphone case, and said first and second sound pressure transmission portions are coupled to said microphone case.

5. An acoustic apparatus according to claim 1, wherein said sound collection portion comprises any one of an electromagnetic conversion type, a capacitor type, a piezoelectric type, and an energy conversion type.

6. An acoustic apparatus comprising:
a support;
a sound generation portion comprising a first vibration plate for generating sound, a driving coil for vibrating said first vibration plate, and a magnetic circuit for generating a magnetic field crossing said driving coil;
a sound collection portion coupled to said support comprising a second vibration plate for collecting sound, a detection coil operating with said second vibration plate, and a magnetic circuit for generating a magnetic field crossing said detection coil; and
an auxiliary coil coupled to said support that vibrates with said first vibration plate during a sound generation caused by vibration of said first vibration plate, and a current circuit including said detection coil and said auxiliary coil;
wherein said current circuit is configured to receive an induced current in said auxiliary coil when the sound generation operation of said first vibration plate vibrates and which said second vibration plate substantially cancels said induced current generated in said auxiliary coil.

7. An acoustic apparatus according to claim 6, wherein said driving coil and said auxiliary coil are coupled to a same side of said first vibration plate.

8. An acoustic apparatus according to claim 7, wherein said driving coil and said auxiliary coil are positioned within a common magnetic circuit.

9. An acoustic apparatus according to claim 7, wherein said driving coil, said detection coil, and said auxiliary coil are wound in a same direction, and a portion of the magnetic fields that cross said driving coil, said detection coil, and said auxiliary coil flow in a same direction.

10. An acoustic apparatus according to claim 6, wherein said driving coil and said auxiliary coil are connected either in series or in parallel within a current circuit.
